(19) United States
(12) Patent Application Publication
(10) Pub. No.: US 2026/0290859 A1
(43) Pub. Date: Sep. 24, 2026

(54) APPARATUS FOR HEAT TRANSFER BETWEEN, WITHIN, AND AMONGST ELECTROCHEMICAL CELLS, ELECTROCHEMICAL CELL STACKS, AND THERMOCHEMICAL REACTORS, SUCH AS A CARBON REACTORS, IN CARBON-OXYGEN BATTERIES AS WELL AS OTHER DEVICES AND USES THEREOF

(71) Applicant: NOON ENERGY, INC., Palo Alto, CA (US)

(72) Inventors: Pawel A. PIOTROWICZ, Santa Clara, CA (US); David BURAK, Mountain View, CA (US); Trevor WOO, San Jose, CA (US); Robert VERDENBURGH, Palo Alto, CA (US); Theis L. SKAFTE, Palo Alto, CA (US); Christopher Ronald GRAVES, Palo Alto, CA (US); Yu-Lun LIANG, Redwood City, CA (US)

(21) Appl. No.: 19/574,121

(22) Filed: Mar. 20, 2026

Related U.S. Application Data
(60) Provisional application No. 63/775,853, filed on Mar. 21, 2025.

(51) Int. Cl. H01M 8/04007; C01B 32/40; H01M 8/04701; H01M 8/0612; H01M 8/12; H01M 8/2428; H01M 8/243; H01M 8/2484

(52) U.S. Cl. CPC H01M 8/04074; C01B 32/40; H01M 8/04708; H01M 8/0631; H01M 8/12; H01M 8/2428; H01M 8/243; H01M 8/2484; H01M 2008/1293; H01M 2250/405

(57) ABSTRACT

Set forth herein are systems and processes for conducting heat between a fuel cell and a reactor. The heat may be conducted using a variety of conduction and convection means.

### CROSS REFERENCE TO RELATED PATENT APPLICATIONS

This patent application claims the benefit of, and priority to, U.S. Provisional Patent Application No. 63/775,853, filed Mar. 21, 2025, the contents of which are incorporated herein by reference in their entirety.

### FIELD

This disclosure concerns energy storage and heat transfer mechanisms and designs between at least one or more electrochemical cell stacks (“stack”) and at least one or more carbon reactors. In some embodiments, the heat transfer between a stack of electrochemical cells and a reactor occurs in a carbon-oxygen battery. Transferring heat between these two components is important for efficient operation of the carbon-oxygen battery. In some embodiments, the heat transfer between a stack of electrochemical cells and a reactor occurs in a device other than a carbon-oxygen battery.

### BACKGROUND OF THE INVENTION

U.S. Pat. No. 9,780,424 B2 describes a carbon-oxygen battery system with a two-step reaction chemistry, operating principle, and related materials. It discloses that the cell stack and carbon reactor should be thermally coupled and shows them adjacent to one another but does not describe how the thermal coupling should be effectively achieved. U.S. Patent Application Publication No. 2020/0358123 A1 describes passive flow battery systems for multiple high-temperature battery chemistries including the carbon-oxygen battery. It discloses heat pipes for passively removing heat from the system during charging and discharging. U.S. Patent Application Publication No. 2020/0358123 A1 does not disclose means for transferring heat between the cell stack and carbon reactor. These issued patents and published patent applications are incorporated by reference in their entirety for all purposes.

Problems in the field to which the instant disclosure pertains remain unsolved, such as, but not limited to, thermal conduction between a fuel cell and a reactor. Set forth herein are solutions to these problems as well as others.

### SUMMARY OF THE INVENTION

This instant disclosure describes, inter alia, how to transfer heat between a carbon reactor and a cell stack [electrochemical cell stack, reversible solid-oxide electrochemical (RSOC) stack] in a carbon-oxygen battery. Heat transfer mechanisms for the battery include convective heat transfer via the fuel gas, convective heat transfer via air, conduction through conductive interfaces designed to thermally connect the carbon reactor and the cell stack, heat pipes designed to thermally connect the carbon reactor and the cell stack, and designs useful for improving radiation heat transfer between the carbon reactor and the stack of electrochemical cells. This instant disclosure sets forth systems, apparatus, and components thereof, that provide a means for conducting heat by one or all of these heat transfer mechanisms between the components in a carbon-oxygen battery.

In one embodiment, set forth herein is a system that includes an electrochemical cell stack; a reactor; and a conductive interface disposed between the stack and the reactor having a thermal conductivity greater than 15 W/(m-K) and a thickness less than 50 cm.

In a second embodiment, set forth herein is a system that includes an electrochemical cell stack; a reactor; a conductive interface disposed between the stack and the reactor having a thermal conductivity greater than 15 W/(m-K) and a thickness less than 50 cm; and means for fuel-side convection.

In a third embodiment, set forth herein is a system that includes an electrochemical cell stack; a reactor; a conductive interface disposed between the stack and the reactor having a thermal conductivity greater than 15 W/(m-K) and a thickness less than 50 cm; and means for air-side convection.

In a fourth embodiment, set forth herein is a carbon-oxygen battery that includes a system described herein.

In a fifth embodiment, set forth herein is a process of using a carbon-oxygen battery described herein.

### BRIEF DESCRIPTION OF DRAWINGS

FIG. 1 shows an embodiment of the instant disclosure with one way of arranging a stack of electrochemical cells and a carbon thermochemical reactor (also referred to herein as a carbon collector or CC).

FIG. 2 shows an embodiment of the instant disclosure. A top view of a carbon reactor and a stack of electrochemical cells is shown on the left. A sliced top view section of same component is shown in the middle. A sliced side view of same component is shown on the right. Not pictured is the conduction interface between the stack of electrochemical cells and the carbon reactor.

FIG. 3 shows an embodiment of the instant disclosure. The left side shows a top-down view of an arrangement of three stacks of solid-oxide electrochemical cells (SOFC stack) and three carbon reactors (aka thermochemical reactors) with a high thermal conduction pathway therebetween. Also shown is thermal insulation around the arrangement. The right side shows a side view of an arrangement of three stacks of solid-oxide electrochemical cells and six carbon reactors with a high thermal conduction pathway therebetween.

FIG. 4 shows an embodiment of the instant disclosure. The left side shows a top-down view of an arrangement of six stacks of solid-oxide electrochemical cells and three carbon reactors with a high thermal conduction pathway therebetween. The right side shows a side view of an arrangement of three stacks of solid-oxide electrochemical cells and six carbon reactors with a high thermal conduction pathway therebetween.

FIG. 5 shows an embodiment of the instant disclosure. The left side shows a top-down view of an arrangement of three stacks of solid-oxide electrochemical cells (labeled SOFC stack) and six carbon reactors (aka thermochemical reactors) with a high thermal conduction pathway therebetween. The right side shows a side view of an arrangement of three stacks of solid-oxide electrochemical cell and six carbon reactors with a high thermal conduction pathway therebetween.

FIG. 6 shows an embodiment of the instant disclosure. The figure shows a top-down view of an arrangement of six stacks of solid-oxide electrochemical cells and six carbon reactors with a high thermal conduction pathway therebetween.

FIG. 7 shows an embodiment of the instant disclosure. The figure shows a top-down view of an arrangement of ten stacks of solid-oxide electrochemical cells and ten carbon reactors with a high thermal conduction pathway therebetween.

FIG. 8 shows an embodiment of a conductive interface useful for conducting heat between a stack of solid-oxide electrochemical cells and a carbon reactor (i.e., thermochemical reactor).

FIG. 9 shows an embodiment of a Stack and Clamp Assembly. The Assembly is useful for conducting heat between a solid-oxide fuel stack and a carbon reactor.

FIG. 10 shows a side view of an embodiment of a clamp assembly and shows the displacement applied to the outer clamp ends.

FIG. 11 shows a front view of an embodiment of an outer clamp assembly.

FIG. 12 shows a top view of an embodiment of an inner clamp assembly.

FIG. 13 shows cladded rods having an inner core and a cladded outer rod.

FIG. 14 shows, on top, an outer clamp and inner clamp assembly, and, on the bottom, the front view of the same.

FIG. 15 shows an embodiment of a center cladded rod positioned in an embodiment of an inner clamp.

FIG. 16 shows, on top, a plot of Stack Power (Watts, W) as a function of time (hours) for a stack of reversible solid-oxide electrochemical cells mechanically coupled to a thermoreactor. FIG. 16 shows, on bottom, a plot of temperature difference (° C.), between the air inlet and air outlet, between the fuel inlet and fuel outlet, between the stack left side exterior and the fuel inlet, as well as between the stack right side exterior and the fuel inlet, as a function of time (hours) for a stack of reversible solid-oxide electrochemical cells that are mechanically coupled to a thermochemical reactor.

### DETAILED DESCRIPTION OF THE INVENTION

### Definitions

As used herein, the term “about,” when qualifying a number, e.g., 15% v/v, refers to the number qualified and optionally the numbers included in a range about that qualified number that includes ±10% of the number. For example, about 15 weight % includes 15 wt. % as well as 13.5 wt. %, 14 wt. %, 14.5 wt. %, 15.5 wt. %, 16 wt. %, or 16.5 wt. %. For example, “about 75° C.,” includes 75° C. as well 68° C., 69° C., 70° C., 71° C., 72° C., 73° C., 74° C., 75° C., 76° C., 77° C., 78° C., 79° C., 80° C., 81° C., 82° C., or 83° C.

As used herein, “selected from the group consisting of” refers to a single member from the group, more than one member from the group, or a combination of members from the group. A member selected from the group consisting of A, B, and C includes, for example, A only, B only, or C only, as well as A and B, A and C, B and C, as well as A, B, and C.

As used herein, the phrase “Boudouard threshold,” means the partial pressure of carbon monoxide, above which carbon is deposited and carbon dioxide is produced and below which carbon reacts with carbon dioxide to produce more carbon monoxide. The Boudouard threshold is a function of temperature and will change with increases or decrease in temperature.

As used herein, the phrase “carbon gasification,” refers to a process whereby solid carbon reacts with carbon dioxide to form carbon monoxide.

As used herein, the phrase “carbon-oxygen battery,” means a system or device for storing energy and for producing electrical energy when the carbon-oxygen battery is charged. As used herein, a carbon-oxygen battery stores energy in the form of solid carbon and either liquid or vapor carbon dioxide. The battery is capable of generating electricity by combining the carbon and carbon dioxide to provide carbon monoxide that reacts in a solid-oxide fuel cell to generate electricity. The battery is capable of being charged by supplying the battery electricity to reverse the chemical processes, in the solid-oxide cell, that produce electricity. An example carbon-oxygen battery is disclosed in U.S. Pat. No. 9,780,424 B2, which issued Oct. 3, 2017, the entire contents of which are herein incorporated by reference in its entirety for all purposes.

As used herein, the phrase “solid-oxide cell stack,” refers to a stack of electrochemical devices. Each electrochemical device has a cathode, an anode, and an electrolyte between the cathode and anode that is made of a solid oxide material. The solid oxide material catalyzes the electrochemical oxidation of chemical reagents to produce electricity. The electrolyte typically conducts oxygen anions from the cathode to the anode. An electrical conductor is placed between each electrochemical device to provide a stack of electrochemical devices. The electrical conductor conducts the electricity generated by the solid-oxide cell and combines the electricity generated by connected cells.

As used herein, the phrase “Boudouard catalysts,” refers to a material that catalyzes the Boudouard reaction. Boudouard catalysts include, but are not limited to, nickel, iron, and cobalt metals.

As used herein, the phrase “thermochemical reactor,” or “carbon collector” or “carbon thermochemical reactor” means a reactor that includes catalysts suitable for performing the Boudouard reaction.

As used herein, the phrase “solid-oxide electrochemical cell stack in fuel cell mode,” refers to the use of a solid-oxide electrochemical cell to generate electricity and optionally heat by reacting a chemical to form a product. For example, a solid-oxide electrochemical cell may react CO and oxygen (O₂) to form CO₂ and generate electricity and heat.

As used herein, the phrase “solid-oxide electrochemical cell stack in electrolyzer mode,” refers to the use of a solid-oxide electrochemical cell to consume electricity and form chemical reactants from chemical products. For example, a solid-oxide electrochemical cell may use electricity to react CO₂ and form CO and O₂.

As used herein, “thickness” of the interface refers to the shortest straight line dimension between an electrochemical cell stack and a reactor that traverses the interface material.

Heat transfer between the carbon reactor and the stack is important in a carbon-oxygen battery for efficient operation of the system. In charge mode the stack operates in electrolysis mode and is endothermic, while the carbon reactor is growing carbon and is exothermic. To operate efficiently, the endothermic heat required by the stack needs to closely match the exothermic heat produced by the carbon reactor. Therefore, the heat produced by the carbon reactor needs to be conducted to the stack in charge mode. In discharge mode the stack operates in fuel cell mode and produces heat from an exothermic reaction, while the carbon reactor gasifies carbon which is endothermic. Therefore, the heat produced by the stack needs to be conducted to the carbon reactor in discharge mode. This disclosure sets forth apparatus, systems, components, and other devices to accomplish this heat transfer between the carbon collector and the stack.

Transferring heat between the stack and the carbon reactor can happen via conduction if the proper conduction pathways are designed into the interface between the stack and the carbon reactor. Heat transfer via conduction can be described by:

$${q}_{cond} = - k \frac{Δ {T}_{SC}}{Δ x} ,$$

where q_{cond} is the heat flux of conduction (W/cm²), k is the thermal conductivity of the material used for the interface (W/m/K), ΔT_{SC} is the difference in temperature between the stack and the carbon reactor (K), and Δx is the distance between the carbon reactor and the stack. To optimize heat transfer via conduction it is important to design a conductive interface with materials with high thermal conductivity (>15 W/m/K) and keep the distance between the carbon reactor and the stack short (<50 cm), and cover a large surface with the conductive interface (>30% of available surface area on the stack). The temperature difference between the stack and the carbon reactor is dictated by the tolerance in system operating conditions.

The thermal interface (also referred to herein as the heat highway, conduction interface, or thermal coupling) of the stack needs to be engineered such that 1) good thermal contact is ensured with the stack; 2) the heat interface does not short the stack if contacting electrical components of the stack to sink heat (interconnects); and 3) the thermal interface comprises a thermally conductive and electrically insulating solid material such as aluminum nitride (AlN), beryllium oxide (BeO), or Boron Nitride (BN). The interface between this solid piece and stack itself also needs to be engineered to ensure thermal contact with the uneven surfaces of the stack itself. For example, a material that is applied as a paste (also containing filler materials of AlN, BeO, or BN) between the stack and the solid material. Another contact material can be a fiber or gasket type material that is compliant and ensures good thermal contact between the pad and the stack while providing electrical insulation.

Utilizing heat pipes to transfer the heat between the stack and carbon collector (CC, also referred to as a thermochemical reactor) is also another heat transfer option. See, for example, https://celsiainc.com/resources/calculators/heat-pipe-calculator/. This will utilize the latent heat of the working fluid to transfer heat. The heat pipe distances are less constrained than the conduction material distance. The heat pipe typically has 1) working fluid; 2) a wick material; and 3) a containment vessel. The heat pipe needs to be made of materials that are functional in the environment of the stack cell and reactor. For example, inconel or hastelloy specialty alloys can make the wick and containment vessel while the working fluid needs to be tuned to vaporize and condense in the interested temperature range, for example, sodium or cesium as working fluids. A heat pipe design would work to replace the conduction interface in the drawings and allow the same amount of heat transfer for significantly lower temperature differences and larger distances between the two reactor components. Depending on the configuration, heat pipes offer 10-100× higher thermal conductivities than copper. Therefore, allowing the distance between the two reactors to grow and the power density of the two reactors to increase. Therefore, for a heat pipe with conservative effective thermal conductivity of >500 W/m/K these configurations can have a distance of <15 m. This effectively removes spatial constraints for heat transfer in these reactors.

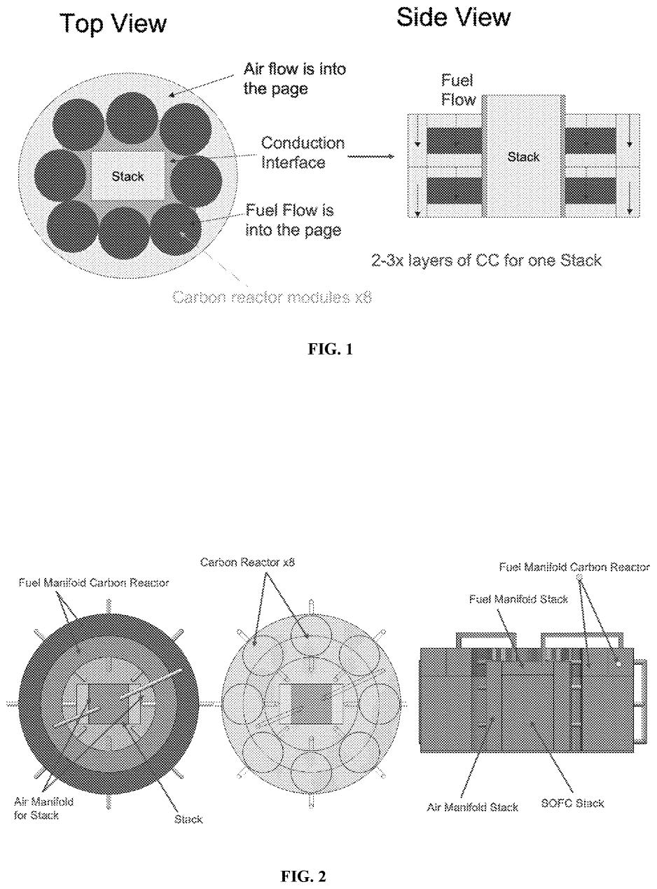

Radiation can also be used for heat transfer. Heat transfer via radiation is calculated as q_rad=σεA [symbol] ΔT [symbol] \hat{ }4, where σ=5.67×10-8 J/s·m²·K⁴ is the Stefan-Boltzmann constant, A is the surface area of the object (m²), and T is its absolute temperature in kelvin (K). The stack and carbon reactor are located central to each other, see FIGS. 1-7 as non-limiting examples. The view factor for radiation favors the exchange of radiation heat transfer between the stack and carbon reactor as there is direct line of sight between the two components. The material of the stack and carbon reactor will have an emissivity close to a black body (e>0.90). The use of reflective materials in the insulation will help reflect the radiation back to the components to help eliminate shadowing of the components from the source of radiation. The temperature difference between the stack and the carbon collector will drive the heat transfer to and from the components. This includes absorbing and reflecting materials.

Convection can also transfer heat between the two components, convective heat transfer requires a heat transfer fluid which in this case would either be the fuel or air that is used in the operation of the stack. The amount of heat that the fluid can move is described by Q_{fluid}=\dot{m} Cₚ ΔT₁₂, where Q_{fluid} is the amount of heat carried by the fluid (W), \dot{m} is the mass flow of the fluid (kg/s), Cₚ is the specific heat of the fluid (kJ/kg/K), and ΔT₁₂ is the temperature difference (K) of the fluid before and after moving Q_{fluid} away from either the stack or the carbon reactor. In some embodiments, ΔT₁₂ is low (<50 deg C.) between components. In some embodiments, the amount of mass flow available for heat transfer is optimized or maximized without affecting other system performance characteristics. Transferring heat from the fluid to a solid object can be described by the convection equation Q_{conv}=hA(T₁−T_{fluid}), where Q_{conv} is the amount of heat that is transferred between the solid object and the fluid, A is the surface area of the solid object, h is the convection coefficient between the fluid and the solid object, T₁ is the temperature of the solid object, and T_{fluid} is the temperature of the fluid. This dictates how much heat is getting moved from the solid to the fluid and we see that we need to expose as much area of the solid as possible to fluid and increase the convection coefficient of the fluid here, since we want to limit drastic temperature differences in the system.

FIG. 1 shows an embodiment of this disclosure. The embodiment in FIG. 1 shows all three mechanisms of transferring heat. These mechanisms include a conduction interface made of highly conductive material that can survive a high temperature air environment. In some embodiments, the conduction interface is a solid block of material. In some embodiments, the conduction interface is a porous material foam. In some embodiments, the conduction interface includes fins connecting the outside of the carbon reactor to the conduction interface of a stack. In some embodiments, both fuel and air are flown through the stack and transfer heat to it. The fuel then flows to the inside of the carbon reactor to facilitate the reactions occurring there, the air is directed to outside the carbon reactor where it is not exposed to the reactant inside the carbon reactor. In some embodiments, the air moving on the outside surface area of the carbon reactor only does so to facilitate heat transfer.

On the left side of FIG. 1, there are eight carbon thermochemical reactor modules (also referred to herein as carbon collectors). These modules surround a conduction interface that contacts a stack of electrochemical cells. Air flow is shown as moving into the page. Fuel flow is also shown as moving into the page. On the right side of FIG. 1, multiple layers of a carbon thermochemical reactor are shown in a side view perspective of what is shown on the left side of FIG. 1. In some embodiments, the carbon thermochemical reactor includes Boudouard reaction catalysts. In some embodiments, the electrochemical cells are solid-oxide electrochemical cells that can operate reversibly in electrolyzer mode as well as fuel cell mode.

FIG. 2 shows three perspectives of a fuel manifold and carbon thermochemical reactor that surrounds a stack of electrochemical cells. In some embodiments, the carbon thermochemical reactor includes Boudouard reaction catalysts. In some embodiments, the electrochemical cells are solid-oxide electrochemical cells that can operate reversibly in electrolyzer mode as well as fuel cell mode. In the middle of FIG. 2, eight carbon thermochemical reactors are displayed. On the right side of FIG. 2, the system is shown from a side view. The solid-oxide fuel cell (SOFC), which can reversibly operate as a solid-oxide electrolyzer cell, is in the middle and surrounded by the fuel manifold and carbon thermochemical reactor. Also shown is a fuel manifold stack and an air manifold stack.

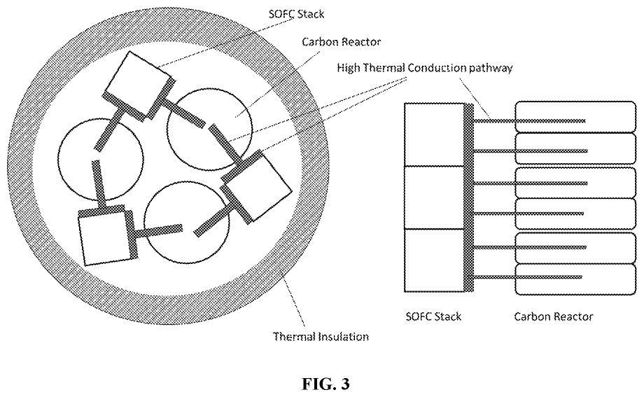

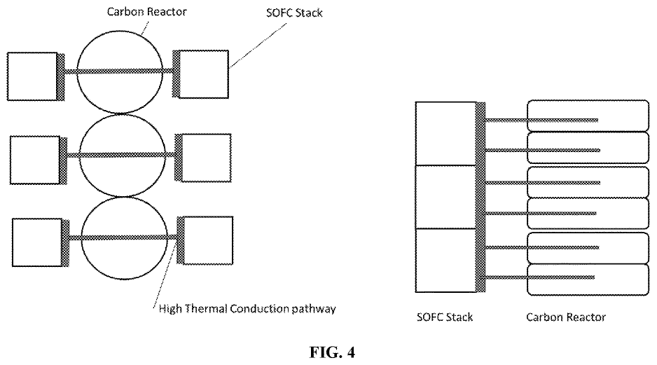

FIG. 3 shows three stacks of solid-oxide fuel cells (SOFC) and three carbon reactors in between each SOFC stack. High thermal conduction pathways are shown as means for conducting heat between these stacks and reactors. In some embodiments, the carbon reactors include Boudouard reaction catalysts. In some embodiments, the electrochemical cells are solid-oxide electrochemical cells that can operate reversibly in electrolyzer mode as well as fuel cell mode.

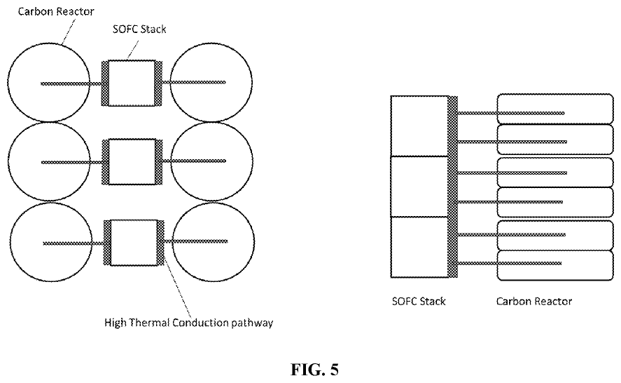

FIG. 4 shows another embodiment in which six stacks of solid-oxide electrochemical cells are coupled to three carbon reactors with a high thermal conduction pathway therebetween. In some embodiments, the carbon reactors include Boudouard reaction catalysts. In some embodiments, the electrochemical cells are solid-oxide electrochemical cells that can operate reversibly in electrolyzer mode as well as fuel cell mode.

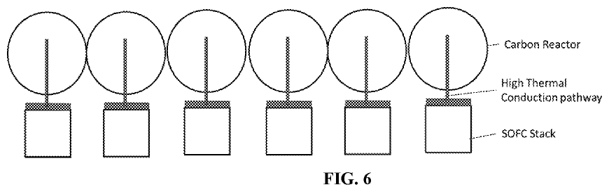

FIG. 5 shows another embodiment in which three stacks of solid-oxide electrochemical cells are coupled to six carbon reactors with a high thermal conduction pathway therebetween. In some embodiments, the carbon reactors include Boudouard reaction catalysts. In some embodiments, the electrochemical cells are solid-oxide electrochemical cells that can operate reversibly in electrolyzer mode as well as fuel cell mode.

FIG. 6 shows another embodiment in which six stacks of solid-oxide electrochemical cells (SOFC stacks) are coupled with six carbon reactors with a high thermal conduction pathway therebetween. In some embodiments, the carbon reactors include Boudouard reaction catalysts. In some embodiments, the electrochemical cells are solid-oxide electrochemical cells that can operate reversibly in electrolyzer mode as well as fuel cell mode.

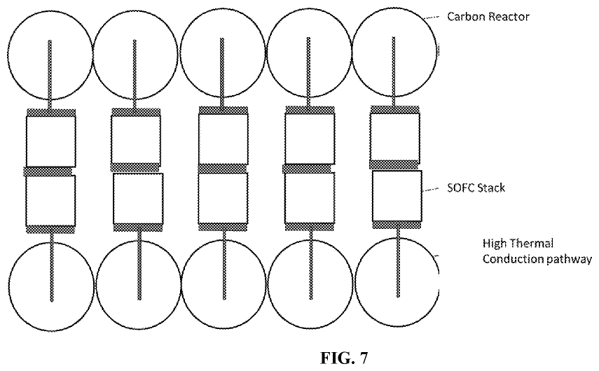

FIG. 7 shows another embodiment in which ten stacks of solid-oxide electrochemical cells are coupled with twenty carbon reactors with a high thermal conduction pathway therebetween. In some embodiments, the carbon reactors include Boudouard reaction catalysts. In some embodiments, the electrochemical cells are solid-oxide electrochemical cells that can operate reversibly in electrolyzer mode as well as fuel cell mode.

FIGS. 1-7 show non-limiting means for air-side convection as well as means for fuel-side convection.

### EMBODIMENTS

Set forth herein is a system that includes an electrochemical cell stack; a reactor; and a conductive interface disposed between the stack and the reactor having a thermal conductivity greater than 15 W/(m-K) and a thickness less than 50 cm.

In some embodiments, including any of the foregoing, the system includes a means for air-side convection.

In some embodiments, including any of the foregoing, the system includes a means for fuel-side convection.

Also set forth herein is a system that includes an electrochemical cell stack; a reactor; and a means for air-side convection.

In some embodiments, including any of the foregoing, the system includes a conductive interface disposed between the stack and the reactor having a thermal conductivity greater than 15 W/(m-K) and a thickness less than 50 cm.

In some embodiments, including any of the foregoing, the system includes means for fuel-side convection.

Also set forth herein is a system that includes an electrochemical cell stack; a reactor; a conductive interface disposed between the stack and the reactor having a thermal conductivity greater than 15 W/(m-K) and a thickness less than 50 cm; and means for fuel-side convection.

In some embodiments, including any of the foregoing, the system includes means for air-side convection.

Also set forth herein is a system that includes an electrochemical cell stack; a reactor; a conductive interface disposed between the stack and the reactor having a thermal conductivity greater than 15 W/(m-K) and a thickness less than 50 cm; and means for air-side convection.

In some embodiments, including any of the foregoing, the system includes means for fuel-side convection.

Also set forth herein is a system that includes an electrochemical cell stack; a reactor; means for air-side convection; and means for fuel-side convection.

In some embodiments, including any of the foregoing, the system includes a conductive interface disposed between the stack and the reactor having a thermal conductivity greater than 15 W/(m-K) and a thickness less than 50 cm.

Also set forth herein is a system that includes an electrochemical cell stack; a reactor; a conductive interface disposed between the stack and the reactor having a thermal conductivity greater than 15 W/(m-K) and a thickness less than 50 cm; means for air-side convection; and means for fuel-side convection.

In some embodiments, including any of the foregoing, the interface has a thermal conductivity greater than 100 W/(m-K), greater than 150 W/(m-K), greater than 200 W/(m-K), greater than 250 W/(m-K), or greater than 300 W/(m-K).

In some embodiments, including any of the foregoing, the interface has a thermal conductivity less than 100,000 W/(m-K); less than 75,000 W/(m-K); less than 60,000 W/(m-K); less than 50,000 W/(m-K); less than 40,000 W/(m-K); less than 30,000 W/(m-K); less than 20,000 W/(m-K); less than 10,000 W/(m-K); or less than 4000 W/(m-K).

In some embodiments, including any of the foregoing, the interface has a thermal conductivity greater than 15 W/(m-K) but less than 100,000 W/(m-K).

In some embodiments, including any of the foregoing, the thickness is less than 50 cm.

In some embodiments, including any of the foregoing, the interface has a thermal conductivity greater than 100 W/(m-K) but less than 100,000 W/(m-K).

In some embodiments, including any of the foregoing, the interface has a thickness is less than 100 cm.

In some embodiments, including any of the foregoing, the interface has a thermal conductivity greater than 200 W/(m-K).

In some embodiments, including any of the foregoing, either the conductive interface disposed between the stack and the reactor has a thickness that is at least 1.5 m.

In some embodiments, including any of the foregoing, the conductive interface disposed between the stack and the reactor has a thickness that is at least 1.5 m.

In some embodiments, including any of the foregoing, the thermal interface material includes silver (Ag), gold (Au), copper (Cu), aluminum (Al), aluminum nitride (AlN), beryllium oxide (BeO), boron nitride (BN), silicon carbide (SiC), Cu-graphite, molybdenum (Mo), aluminum-silicon-carbide (Al—SiC), nickel (Ni), tungsten (W), alloys thereof, composites thereof, or combinations thereof.

In some embodiments, including any of the foregoing, the thermal interface material includes nickel based super alloys such as, but not limited to, inconel (600, 625, etc), hastealloy (X & C), as well as high temp stainless (310S & 253MA). In certain embodiments, these alloys would sandwich the aforementioned high conductivity alloys.

In some embodiments, including any of the foregoing, the interface is a composite of two or more materials.

In some embodiments, including any of the foregoing, the two or more materials are layered.

In some embodiments, including any of the foregoing, the two or more materials are mixed.

In some embodiments, including any of the foregoing, the composite includes a metal layer sandwiched between two other material layers.

In some embodiments, including any of the foregoing, the interface is a solid block of material.

In some embodiments, including any of the foregoing, the interface is a porous material foam.

In some embodiments, including any of the foregoing, the interface includes fins connecting the outside of the carbon reactor to the conduction interface of a stack.

In some embodiments, including any of the foregoing, the air-side convection is across the reactor.

In some embodiments, including any of the foregoing, the stack is a high temperature reversible electrochemical cell stack.

In some embodiments, including any of the foregoing, the reactor is a thermochemical reactor.

In some embodiments, including any of the foregoing, the reactor is a carbon reactor.

In some embodiments, including any of the foregoing, the reactor is a thermochemical Boudouard carbon reactor in a carbon-oxygen battery.

In some embodiments, including any of the foregoing, the reactor is a latent heat storage component.

In some embodiments, including any of the foregoing, the stack is surrounded by two or more reactors.

In some embodiments, including any of the foregoing, the reactor is surrounded by two or more electrochemical cell stacks.

In some embodiments, including any of the foregoing, the reactor is a manifold that surrounds the stack.

Also set forth herein is a carbon-oxygen battery that includes a system disclosed herein.

In some embodiments, including any of the foregoing, the carbon-oxygen battery is arranged as in any one of FIGS. 1-8. For example, the carbon-oxygen battery may include solid-oxide electrochemical cell stacks and carbon reactors as shown in FIG. 1. For example, the carbon-oxygen battery may include solid-oxide electrochemical cell stacks and carbon reactors as shown in FIG. 2. For example, the carbon-oxygen battery may include solid-oxide electrochemical cell stacks and carbon reactors as shown in FIG. 3. For example, the carbon-oxygen battery may include solid-oxide electrochemical cell stacks and carbon reactors as shown in FIG. 4. For example, the carbon-oxygen battery may include solid-oxide electrochemical cell stacks and carbon reactors as shown in FIG. 5. For example, the carbon-oxygen battery may include solid-oxide electrochemical cell stacks and carbon reactors as shown in FIG. 6. For example, the carbon-oxygen battery may include solid-oxide electrochemical cell stacks and carbon reactors as shown in FIG. 7.

Also set forth herein is a process of using a carbon-oxygen battery that is set forth herein, including charging the battery, discharging the battery, or both.

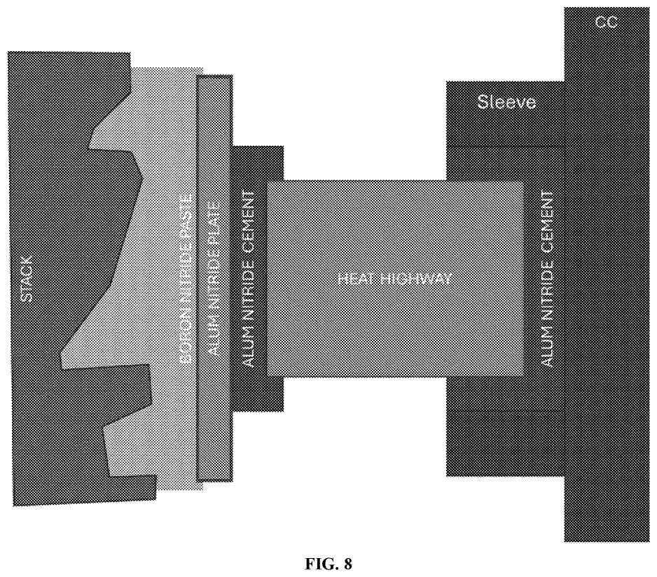

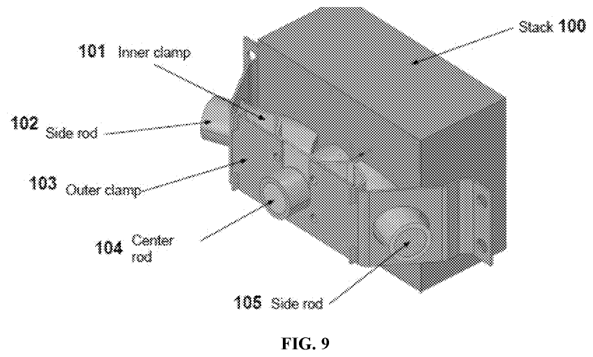

FIG. 8 shows an embodiment of a conductive interface useful for conducting heat between a solid-oxide electrochemical cell fuel stack and a carbon reactor. On the left side, is an exterior surface of a SOFC stack, which is labeled as “Stack,” in FIG. 8. Adjacent to, and in contact with, the Stack is a boron nitride paste layer. Adjacent to, and in contact with, the boron nitride paste layer is an aluminum nitride plate, which is labeled as “ALUM NITRIDE PLATE”. Adjacent to, and in contact with, the aluminum nitride plate is an aluminum nitride cement, which is labeled as “ALUM NITRIDE CEMENT” in FIG. 8. A “heat highway” is positioned between, and in contact with, the aluminum nitride cement that contacts the aluminum nitride plate and another aluminum nitride cement layer that is adjacent to, and in contact with, the sleeve of a carbon collector (i.e., carbon reactor). The heat highway can be selected from a variety of conductive materials. In some embodiments, the heat highway is a cladded rod, for example, a cladded rod shown in FIGS. 9, 13, and 15. In certain of these embodiments, the cladded rod is a copper-coated stainless steel rod. In FIG. 8, the aluminum nitride paste is a non-electrically conductive coating.

In some embodiments, a stack clamp is used to ensure thermal contact between the components labeled in FIG. 8.

The conductive interface useful for conducting heat between a solid-oxide electrochemical cell fuel stack and a carbon reactor in FIG. 8 can be made as follows. First, the carbon collector sleeve is positioned towards the face of a stack of electrochemical cells. Next, the carbon collector sleeve is filled with aluminum nitride paste and a stainless-steel cladded copper rod is sandwiched between the aluminum nitride paste in the carbon collector sleeve and a layer of aluminum nitride paste on the opposite side of the stainless-steel cladded copper rod. To that second layer of aluminum nitride paste, an aluminum nitride plate is applied. Next on the opposing side of the aluminum nitride plate, the face of a stack is affixed using a layer of boron nitride paste.

The carbon collector sleeve can be made from stainless steel in certain embodiments.

FIG. 9 shows one means for conducting heat between a stack of solid-oxide fuel cells and a carbon reactor. The stack of solid-oxide fuel cells is shown as a large rectangular shape on the right side and labeled 100. A center rod, labeled 104, and two side rods, labeled 102 and 105 contact the stack 100. The center rod and side rods are conductive to heat and useful for conducting heat between the stack and a carbon reactor (not shown). The center rod and side rods are held against the stack, 100, by an outer clamp, 103, and an inner clamp, 101.

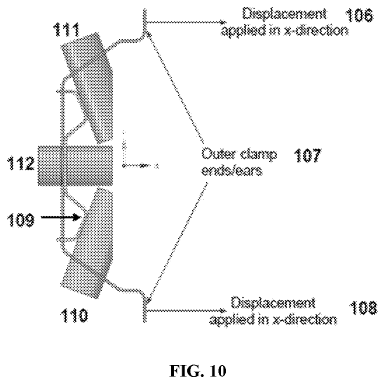

FIG. 10 shows a side view of an embodiment of a clamp shown in FIG. 9. The clamp assembly is engaged by, or attached to the stack of electrochemical cells, by applying a displacement on the outer clamp ends. The magnitude of the displacement is variable. The displacement applied in the x-direction is shown at 106 and 108. The outer clamp ends/ears are shown at 107. Also shown is an inner clamp 109. Also shown is a side view of center rod 112 and side rods 110 and 111. The inner clamp 109 has an inner clamp pad that contacts the side rod but is not labeled in FIG. 10. Once a displacement is applied to the outer clamp, the inner clamp pads push the rods into the stack of electrochemical cells. In some embodiments, there is a 25 mm gap between the inner clamp pads and the rods. This distance may be varied depending on the embodiment of this clamp assembly.

In some embodiments, the contact between the inner clamp, 109, and the outer rod surface to which it contacts is characterized by a low friction contact. For example, in some embodiments, the frictional coefficient is 0.1, 0.2, 0.3, 0.4, or 0.5.

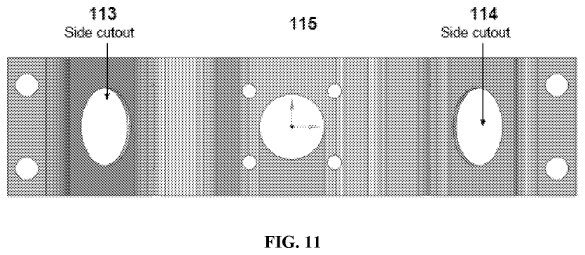

FIG. 11 shows a front view of the outer clamp assembly. Shown are side cutouts 113 and 114 through which the side rods engage. Shown is a center cutout 115 through which the center rod engages. The cutouts in the outer clamp support and engage the center and side rods.

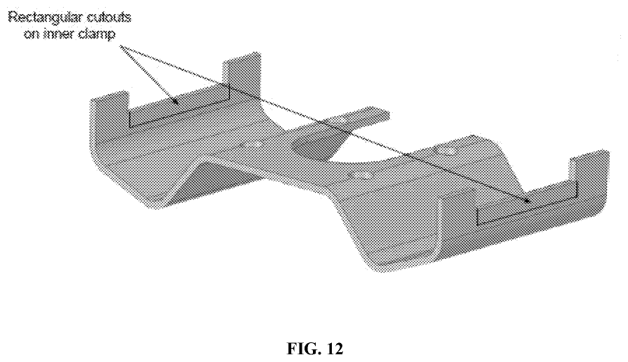

FIG. 12 shows a top view of the inner clamp assembly. Shown are rectangular cutouts on the inner clamp. The rectangular cutouts can be added to the inner clamp to add flexibility to the inner clamp.

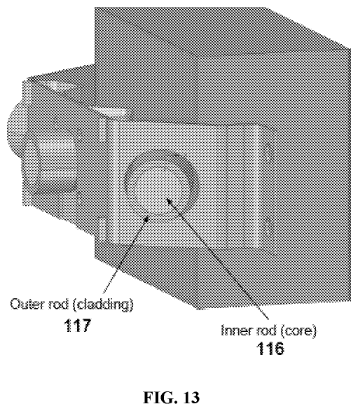

FIG. 13 shows a clamp assembly in contact with a stack of electrochemical cells. Shown is a side cladded rod. The side rod is made of an inner rod or core labeled as 116. Around this core is an outer rod or cladding labeled as 117. Each rod assembly, including the center rod and side rods, are made of an inner rod and an outer rod. The inner rod is, in certain embodiments, made of copper or a copper alloy. The outer rod is made in certain embodiments of stainless steel. The inner rod and outer rod are related as a core is to the cladding around the core.

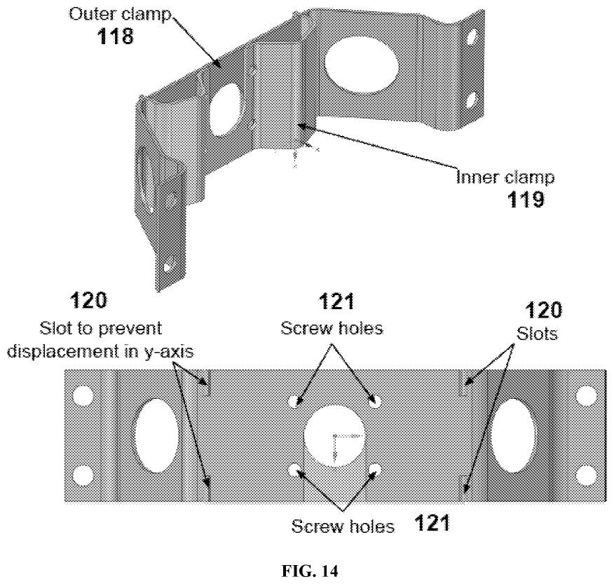

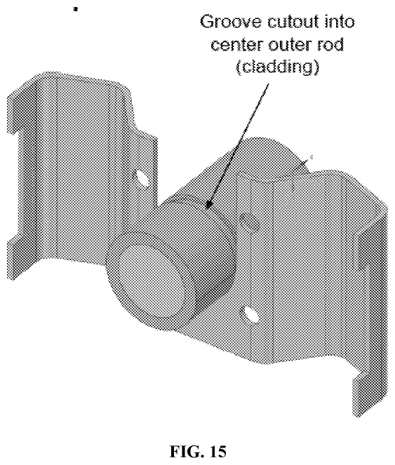

FIG. 14 shows views of an inner clamp, 119, and an outer clamp, 118, in an embodiment. The outer clamp, 118, includes slots labeled 120 that prevent displacement in the y-axis. The outer clamp, 118, also includes screw holes labeled 121. The outer clamp and inner clamp are held together by screws through these screw holes. The inner clamp is configured to slide into the slots, 120, which prevent the inner clamp from translating in the y-direction when the clamp assembly is engaged.

FIG. 15 shows a center rod (cladding) to an inner and an outer clamp. FIG. 15 shows a cutout on the outer rod (cladding) that is configured to allow the inner and outer clamps to slot into the inner clamp. The groove also contains a chamfer that should be removed before meshing.

### EXAMPLES

### Example 1—Heat Highway Performance

A stack of reversible solid-oxide electrochemical cells was assembled. The system was operated in charge and discharge mode.

A stack of electrochemical cells was provided that included electrochemically active catalysts for H₂/H₂O/CO/CO₂/CH₄ reactions. The cells included Zirconia-based electrolytes and included positive electrodes air and negative electrodes with H₂/H₂O/CO/CO₂/CH₄ fuel inlets. A stack was assembled that included 65 electrochemical cells. The electrochemical cell was kept at an isothermal kiln that kept the environment at near 750° C. target temperature. Both the air and fuel gas streams were also heated up by the kiln to the same target temperature before being fed into the electrochemical cell. After reaching temperature equilibrium, a series of two operation modes were applied to the electrochemical cell: (1) a positive current or higher-than-equilibrium voltage was applied in the electrolysis mode (charging); and (2) a negative current or lower-than-equilibrium voltage was applied in the fuel cell mode (discharging). During the operations, temperature measurements were continuously monitored in the following locations: inlet and outlet of the air stream, inlet and outlet of the fuel stream, near the surface of the electrochemical cell, near the heat transfer apparatus, and the environment.

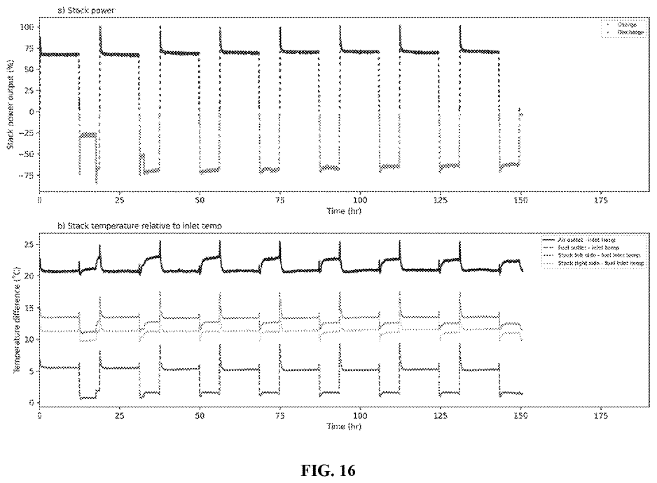

See FIG. 16 for a plot of the Stack Power (W) during charge and discharge modes as a function of the number of hours operated. See FIG. 16 for a plot of the temperature difference between the air inlet and air outlet as well as between the stack left side and stack right side during charge and discharge modes as a function of the number of hours operated.

The flow of air on the air channels was 66 standard liters per minute (SLPM). The fuel flow was less than 12 SLPM (mode dependent). Calculations assumed near complete insulation and no heat exchange. These calculations showed that the net heat difference on the stack only is 151.4 W. Assuming 80% of heat energy goes to the air side, estimated from the flow rate ratio, that is about a 120 W of heat difference between the charging and discharging mode.

The air stream supplied to the air channels was at a substantially higher volumetric flow rate than the fuel stream. Under an idealized assumption of negligible heat losses, the difference in heat release between charging and discharging modes produces a net thermal gradient in the stack. Based on the flow rates of the process streams, a majority fraction of this heat (e.g., on the order of ~80%) would be expected to transfer to the air stream.

Using the heat capacity of the air stream and the nominal operating flow conditions, a simple energy balance predicts that this thermal gradient in the stack would result in an outlet-inlet temperature difference on the air stream on the order of ~100° C. between inlet and outlet. However, experimental cycling data show that the observed thermal gradient is less than ~5° C.

For example, using the heat capacity of air, on 66 liters per minute (LPM) of air at high temperature, there should be about a 100° C. difference in temperature between the air outlet and the air inlet between discharging (higher) and charging (lower) modes. However, surprisingly less than 5° C. difference was observed, indicating there was another process modulated the heat on the stack. The heat-modulating process could be the heat conduction or radiation from the heat highway, or the convection within the kiln.

This discrepancy indicates the presence of an additional heat-transfer mechanism that redistributes thermal energy within the system. This mechanism is largely attributed to the conductive interface designed between the stack and carbon reactor (e.g., a thermal conduction pathway or “heat highway”), as well as convective heat exchange within the surrounding enclosure (e.g., kiln environment). At present, the relative contributions of these mechanisms have not been independently quantified.

The embodiments and examples described herein are intended to be merely illustrative and non-limiting. Those skilled in the art will recognize or will be able to ascertain using no more than routine experimentation, numerous equivalents of specific compounds, materials, and procedures. All such equivalents are considered to be within the scope of this disclosure and are encompassed by the appended claims.

What is claimed is:

1. A system comprising
an electrochemical cell stack;
a reactor; and
a conductive interface disposed between the stack and the reactor having a thermal conductivity greater than 15 W/(m-K) and a thickness less than 50 cm.

2. The system of claim 1, further comprising a means for air-side convection.

3. The system of claim 1 or 2, further comprising a means for fuel-side convection.

4. A system comprising
an electrochemical cell stack;
a reactor; and
a means for air-side convection.

5. The system of claim 4, further comprising a conductive interface disposed between the stack and the reactor having a thermal conductivity greater than 15 W/(m-K) and a thickness less than 50 cm.

6. The system of claim 4 or 5, further comprising means for fuel-side convection.

7. A system comprising
an electrochemical cell stack;
a reactor;
a conductive interface disposed between the stack and the reactor having a thermal conductivity greater than 15 W/(m-K) and a thickness less than 50 cm; and
means for fuel-side convection.

8. The system of claim 7, further comprising means for air-side convection.

9. A system comprising
an electrochemical cell stack;
a reactor;
a conductive interface disposed between the stack and the reactor having a thermal conductivity greater than 15 W/(m-K) and a thickness less than 50 cm; and
means for air-side convection.

10. The system of claim 9, further comprising means for fuel-side convection.

11. A system comprising
an electrochemical cell stack;
a reactor;
means for air-side convection; and
means for fuel-side convection.

12. The system of claim 9, further comprising a conductive interface disposed between the stack and the reactor having a thermal conductivity greater than 15 W/(m-K) and a thickness less than 50 cm.

13. A system comprising
an electrochemical cell stack;
a reactor;
a conductive interface disposed between the stack and the reactor having a thermal conductivity greater than 15 W/(m-K) and a thickness less than 50 cm;
means for air-side convection; and
means for fuel-side convection.

14. The system of any one of claims 1-13, wherein the interface has a thermal conductivity greater than 100 W/(m-K), greater than 150 W/(m-K), greater than 200 W/(m-K), greater than 250 W/(m-K), or greater than 300 W/(m-K).

15. The system of claim 14, wherein the interface has a thermal conductivity less than 100,000 W/(m-K); less than 75,000 W/(m-K); less than 60,000 W/(m-K); less than 50,000 W/(m-K); less than 40,000 W/(m-K); less than 30,000 W/(m-K); less than 20,000 W/(m-K); less than 10,000 W/(m-K); or less than 4000 W/(m-K).

16. The system of any one of claims 1-13, wherein the interface has a thermal conductivity greater than 15 W/(m-K) but less than 100,000 W/(m-K).

17. The system of claim 16, wherein the thickness is less than 50 cm.

18. The system of any one of claims 1-13, wherein the interface has a thermal conductivity greater than 100 W/(m-K) but less than 100,000 W/(m-K).

19. The system of claim 18, wherein the interface has a thickness is less than 100 cm.

20. The system of any one of claims 1-13, wherein the interface has a thermal conductivity greater than 200 W/(m-K).

21. The system of any one of claims 1-20, either conductive interface disposed between the stack and the reactor having a thickness that is at least 1.5 m; or further comprising a conductive interface disposed between the stack and the reactor having a thickness that is at least 1.5 m.

22. The system of any one of claims 1-21, wherein the thermal interface material comprises silver (Ag), gold (Au), copper (Cu), aluminum (Al), aluminum nitride (AlN), beryllium oxide (BeO), boron nitride (BN), silicon carbide (SiC), Cu-graphite, molybdenum (Mo), aluminum-silicon-carbide (Al—SiC), nickel (Ni), tungsten (W), alloys thereof, composites thereof, or combinations thereof.

23. The system of any one of claims 1-22, wherein the interface is a composite of two or more materials.

24. The system of claim 23, wherein the two or more materials are layered.

25. The system of claim 23, wherein the two or more materials are mixed.

26. The system of claim 23, wherein the composite comprises a metal layer sandwiched between two other material layers.

27. The system of any one of claims 1-26, wherein the interface is a solid block of material.

28. The system of any one of claims 1-26, wherein the interface is a porous material foam.

29. The system of any one of claims 1-28, wherein the interface comprises fins connecting the outside of the carbon reactor to the conduction interface of a stack.

30. The system of any one of claims 1-29, wherein the air-side convection is across the reactor.

31. The system of any one of claims 1-30, wherein the stack is a high temperature reversible electrochemical cell stack.

32. The system of any one of claims 1-31, wherein the reactor is a thermochemical reactor.

33. The system of any one of claims 1-32, wherein the reactor is a carbon reactor.

34. The system of any one of claims 1-33, wherein the reactor is a thermochemical Boudouard carbon reactor in a carbon-oxygen battery.

35. The system of any one of claims 1-34, wherein the reactor is a latent heat storage component.

36. The system of any one of claims 1-35, wherein the stack is surrounded by two or more reactors.

37. The system of any one of claims 1-36, wherein the reactor is surrounded by two or more electrochemical cell stacks.

38. The system of any one of claims 1-37, wherein the reactor is a manifold that surrounds the stack.

39. A carbon-oxygen battery comprising the system of any one of claims 1-38.

40. At least one or more carbon-oxygen batteries of claim 39, wherein the carbon-oxygen batteries are arranged as in any one of FIGS. 1-7.

41. A process of using the carbon-oxygen battery of claim 39 or 40, comprising charging the battery, discharging the battery, or both.

42. A system comprising
at least one reversible solid-oxide electrochemical cell stack; and
a plurality of thermochemical reactors;
wherein the plurality of thermochemical reactors surround a conductive interface that surrounds the at least one reversible solid-oxide electrochemical cell stack;
wherein the conductive interface has a thermal conductivity greater than 15 W/(m-K) and a thickness less than 50 cm.

43. The system of claim 42, comprising eight thermochemical reactors surrounding the at least one reversible solid-oxide electrochemical cell stack.

44. The system of claim 42, comprising air flow, fuel flow, or both, parallel to direction of stacking in the at least one reversible solid-oxide electrochemical cell stack.

45. The system of claim 42, comprising three thermochemical reactors and three reversible solid-oxide electrochemical cell stacks, wherein each reversible solid-oxide electrochemical cell stack is located between two thermochemical reactors and each thermochemical reactor is coupled to a reversible solid-oxide electrochemical cell stack by a conductive interface.

46. The system of claim 45, wherein the three thermochemical reactors and three reversible solid-oxide electrochemical cell stacks are arranged in a substantially circular pattern.

47. The system of claim 45, wherein the three thermochemical reactors and three reversible solid-oxide electrochemical cell stacks are arranged in a substantially hexagonal pattern.

48. The system of claim 45, wherein one conductive interface thermally couples one reversible solid-oxide electrochemical cell stack to two thermochemical reactors.

49. A system comprising
at least one thermochemical reactor; and
a plurality of reversible solid-oxide electrochemical cell stacks;
wherein at least two of the plurality of reversible solid-oxide electrochemical cell stacks are thermally coupled to, and surround, the at least one thermochemical reactor;
wherein a conductive interface thermally couples the at least two of the plurality of reversible solid-oxide electrochemical cell stacks to the thermochemical reactor;
wherein the conductive interface has a thermal conductivity greater than 15 W/(m-K) and a thickness less than 50 cm.

50. The system of claim 49, wherein the at least two of the plurality of reversible solid-oxide electrochemical cell stacks are thermally coupled to each other by the conductive interface.

51. The system of claim 49 or 50, comprising three thermochemical reactors and six reversible solid-oxide electrochemical cell stacks, all thermally coupled to each other by the conductive interface.

52. A system comprising at least one reversible solid-oxide electrochemical cell stack; and
a plurality of thermochemical reactors;
wherein at least two of the plurality of thermochemical reactors are thermally coupled to, and surround, the at least one reversible solid-oxide electrochemical cell stack;
wherein a conductive interface thermally couples the at least two of the plurality of thermochemical reactors to the at least one reversible solid-oxide electrochemical cell stack;
wherein the conductive interface has a thermal conductivity greater than 15 W/(m-K) and a thickness less than 50 cm.

53. The system of claim 52, wherein the at least two of the plurality of thermochemical reactors are thermally coupled to each other.

54. The system of claim 49 or 50, comprising three reversible solid-oxide electrochemical cell stacks and six thermochemical reactors, all thermally coupled to each other by the conductive interface.

55. A system comprising:
a plurality of thermochemical reactors and a plurality of reversible solid-oxide electrochemical cell stacks,
wherein at least one of plurality of thermochemical reactors is thermally coupled to at least one of the plurality of reversible solid-oxide electrochemical cell stacks by way of a conductive interface;
wherein the conductive interface has a thermal conductivity greater than 15 W/(m-K) and a thickness less than 50 cm.

56. A system comprising:
a plurality of thermochemical reactors and a plurality of reversible solid-oxide electrochemical cell stacks,
wherein at least two of plurality of thermochemical reactors are thermally coupled to at least two of the plurality of reversible solid-oxide electrochemical cell stacks by way of a conductive interface;
wherein the conductive interface has a thermal conductivity greater than 15 W/(m-K) and a thickness less than 50 cm.

57. A system comprising:
a plurality of thermochemical reactors and a plurality of reversible solid-oxide electrochemical cell stacks,
wherein at least two of plurality of reversible solid-oxide electrochemical cell stacks are thermally coupled to each other by a conductive interface;
wherein each thermochemical reactor is thermally coupled to at least one of the plurality of reversible solid-oxide electrochemical cell stacks by way of a conductive interface;
wherein the conductive interface has a thermal conductivity greater than 15 W/(m-K) and a thickness less than 50 cm.

58. The system of any one of claims 49-57, wherein the conductive interface is substantially as shown in FIG. 8.

59. The system of any one of claims 49-58, wherein the conductive interface comprises a first aluminum nitride cement in contact with the thermochemical reactor.

60. The system of any one of claims 49-58, wherein the conductive interface comprises a boron nitride paste in contact with the reversible solid-oxide electrochemical cell stack.

61. The system of claim 59 or 60, further comprising an aluminum nitride plate and a second aluminum nitride paste between the boron nitride paste and the aluminum nitride cement.

62. The system of claim 61, further comprising a heat highway between the first aluminum nitride cement and the second aluminum nitride cement.

63. The system of claim 62, wherein the heat highway is a metal, metal alloy, or a combination thereof.

64. The system of claim 63, wherein the heat highway is silver (Ag), gold (Au), copper (Cu), aluminum (Al), aluminum nitride (AlN), beryllium oxide (BeO), boron nitride (BN), silicon carbide (SiC), Cu-graphite, molybdenum (Mo), aluminum-silicon-carbide (Al—SiC), nickel (Ni), tungsten (W), alloys thereof, composites thereof, or combinations thereof.

65. The system of claim 63, wherein the heat highway is a cladded rod, for example, a cladded rod shown in FIGS. 9, 13, and 15

66. The system of claim 63, wherein the metal is copper, aluminum, nickel, gold, silver, platinum, tin, or a combination thereof.

67. The system of claim 63, wherein the metal alloy is inconel or hastelloy.

68. The system of any one of claims 62-65, wherein the heat highway is configured as shown in FIGS. 9-15.
